(19) United States
(12) Patent Application Publication
(10) Pub. No.: US 2022/0283124 A1
(43) Pub. Date: Sep. 8, 2022

(54) Ultrasonic Testing Device and Ultrasonic Testing Method

(71) Applicant: Hitachi Power Solutions Co., Ltd., Hitachi-shi, Ibaraki (JP)

(72) Inventors: Kaoru SAKAI, Tokyo (JP); Masayuki KOBAYASHI, Tokyo (JP); Osamu KIKUCHI, Ibaraki (JP); Shigeru OONO, Ibaraki (JP); Kotaro KIKUKAWA, Ibaraki (JP)

(21) Appl. No.: 17/636,664

(22) PCT Filed: Aug. 18, 2020
(86) PCT No.: PCT/JP2020/031051

§ 371 Date: Feb. 18, 2022

(30) Foreign Application Priority Data
Aug. 27, 2019 (JP) 2019-154220

(51) Int. Cl. G01N 29/38; G01N 29/04; G01N 29/06; G01N 29/28; G01N 29/11; G01N 29/50

(52) U.S. Cl. CPC G01N 29/38; G01N 29/043; G01N 29/069; G01N 29/28; G01N 29/11; G01N 29/50; G01N 2291/0289; G01N 2291/011; G01N 2291/015

(57) ABSTRACT

Provided is an ultrasonic testing device with which it is possible to suitably detect internal defects in an article to be tested. For this purpose, the ultrasonic testing device comprises: an ultrasonic probe that generates ultrasonic waves and transmits the same to the article to be tested, and that receives reflected waves reflected from the article to be tested; and a computation processing unit. The computation processing unit: (A) sets a gate indicating a start time and a time duration for a subject of analysis of the reflected waves; (B) as pertains to each of a plurality of measurement points, (B1) acquires a reflection signal indicating the intensity of the reflected waves at each time, (B2) calculates a difference signal that is the difference between the reflection signal and a reference signal, and (B3) calculates a feature amount with respect to the difference signal within the gate; (C) detects defects on the basis of the feature amounts for the plurality of measurement points; and (D) outputs information indicating the depth of the defects along the transmission direction of the ultrasonic waves.

### TECHNICAL FIELD

The present invention relates to an ultrasonic testing device and an ultrasonic testing method.

### BACKGROUND ART

As a non-destructive testing method for testing a defect of an article to be tested from an image of the article to be tested, there has been known a method of irradiating the article to be tested with ultrasonic waves and using an ultrasonic image generated by detecting the reflected waves. For example, the summary of Patent Literature 1 below describes “[Problem] Provided is an ultrasonic measuring device that can accurately and stably extract information on internal defects with good reproducibility and can convert the information into a clear image when a plurality of reflection signals are close to each other in a time domain and the waveforms interfere with each other. [SOLUTION] In an ultrasonic measuring device, the surface of a subject 15 is scanned with an ultrasonic probe 16, ultrasonic waves U1 are sent from the ultrasonic probe toward the subject, and reflection echoes U2 coming back from the subject are received. In the device, a computation processor (waveform computation processing program 37) processes received waveform data generated from the reflection echoes, thereby testing internal defects 51 in the subject. The computation processor includes a waveform feature extraction unit that performs wavelet conversion processing on the received waveform data in a state where a plurality of reflection echoes interfere with each other, extracts waveform features of the internal defects, and converts the same into an image.”.

### CITATION LIST

### Patent Literature

Patent Literature 1: JP2010-169558A

### SUMMARY OF INVENTION

### Technical Problem

When a plurality of reflection echoes interfere with each other in the received waveform data, it may not be possible to accurately detect defects in an article to be tested.

The present invention has been made in view of the above circumstances, and an object thereof is to provide an ultrasonic testing device and an ultrasonic testing method which make it possible to suitably detect the internal state of an article to be tested.

### Solution to Problem

To solve the above problems, an ultrasonic testing device according to the present invention includes:

an ultrasonic probe that generates ultrasonic waves and transmits the same to an article to be tested, and that receives reflected waves reflected from the article to be tested; and

a computation processing unit, in which

the computation processing unit:

(A) sets a gate indicating a start time and a time duration for a subject of analysis of the reflected waves;

(B) as pertains to each of a plurality of measurement points,
(B1) acquires a reflection signal indicating the intensity of the reflected waves at each time,
(B2) calculates a difference signal that is the difference between the reflection signal and a reference signal, and
(B3) calculates a feature amount with respect to the difference signal within the gate;

(C) detects defects on the basis of the feature amounts for the plurality of measurement points; and

(D) outputs information indicating the depth of the defects along the transmission direction of the ultrasonic waves.

### Advantageous Effects of Invention

According to the present invention, the internal state of the article to be tested can be suitably detected.

### BRIEF DESCRIPTION OF DRAWINGS

FIG. 1 is a block diagram of an ultrasonic testing device according to a first embodiment of the present invention.

FIG. 2 is a schematic diagram showing the operating principles of the ultrasonic testing device.

FIG. 3 is a cross-sectional view of an example of a specimen.

FIG. 4 is a diagram showing an example of a reflection signal.

FIG. 5 is a cross-sectional view of another example of the specimen.

FIG. 6 is a diagram showing another example of the reflection signal.

FIG. 7 is a diagram showing another example of the reflection signal.

FIG. 8 is a flowchart of an ultrasonic testing program.

FIG. 9 is an example of a waveform diagram of a reflection signal and a reference signal.

FIG. 10 is a waveform diagram showing an example of a difference signal and a correlation coefficient.

FIG. 11 is a waveform diagram showing an example of a normalized reflection signal, a reference signal, a difference signal, and a partial correlation coefficient.

FIG. 12 is a diagram showing an example of a feature calculation gate and a corresponding cross-sectional image.

FIG. 13 is an operation explanatory diagram for acquiring a reference signal in a second embodiment.

### DESCRIPTION OF EMBODIMENTS

### First Embodiment

### Overview of First Embodiment

Generally, in order to detect defects existing inside a multi-layer article to be tested with ultrasonic waves, the reflection characteristics due to the difference in acoustic impedance are often used. When ultrasonic waves propagate in a liquid or solid substance, reflected waves (echoes) are generated at the boundary surfaces and voids of substances with different acoustic impedances. Here, the reflected waves generated by defects such as exfoliation, voids, and cracks tend to have a higher intensity than the reflected waves from a location without any defects. Therefore, in an ultrasonic testing device, a gate (time duration) is set assuming a time zone in which the irradiated ultrasonic waves are reflected and received at a desired boundary surface. Then, by generating an image of the intensity of the reflected waves in the gate, defects such as exfoliation present at a joint interface in the article to be tested can be revealed in the test image. As will be described later, the gate has a start time other than the time duration.

However, recent articles to be tested such as LSI (Large Scale Integration) have a structure in which thin film layers are laminated. Therefore, reflected waves from the boundary surfaces of the layers are received at times close to each other. This causes a problem that the reflected waves interfere with each other, making it difficult to clearly distinguish the reflected waves from a desired boundary surface from those from other boundary surfaces. Therefore, even when the article to be tested has a defect, a signal corresponding to the defect is distorted or buried due to the interference, making it difficult to detect the defect. In the following description, “reflected waves” mean ultrasonic waves reflected from boundary surfaces or the like. A “reflection signal” is a signal indicating the intensity of the reflected waves at each time. In this specification, a “signal” refers to an analog format signal and also includes digitized data.

In this embodiment, the main article to be tested is an electronic component having a plurality of joint interfaces, such as an integrated circuit in which extremely thin chips are laminated. Even when reflected waves from the interfaces are generated at times close to each other and are received as a combined reflection signal, reflected waves from defects are detected separately from those from the other joint interfaces, thus making it possible to specify the depth of occurrence. That is, in this embodiment, the reflected waves from the plurality of joint interfaces are close to each other in the time direction, and a difference from a reference signal is calculated for the reflection signal obtained as a combined signal thereof to obtain a difference signal. This difference signal reveals the difference between the reference signal and the reflection signal.

### Configuration of First Embodiment

### (Overall Configuration)

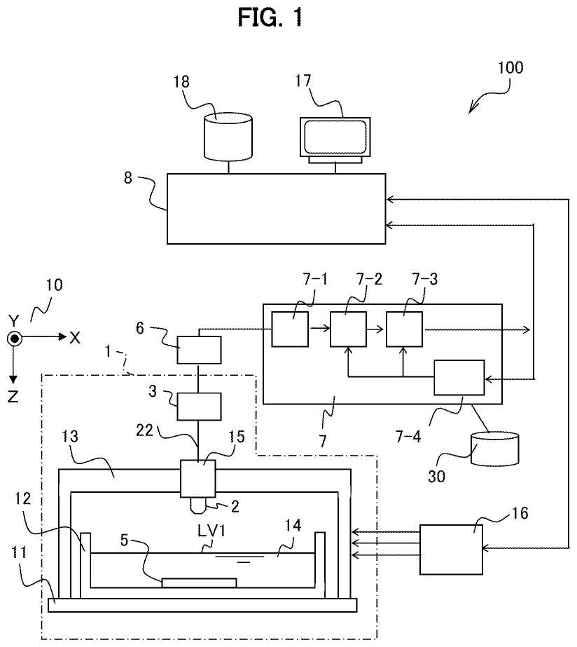

FIG. 1 is a block diagram of an ultrasonic testing device 100 according to the first embodiment of the present invention.

In FIG. 1, the ultrasonic testing device 100 includes a detector 1, an A/D converter 6, a signal processor 7 (computation processing unit), an overall control unit 8 (computation processing unit), and a mechanical controller 16. A coordinate system 10 shown in FIG. 1 has three orthogonal axes of X, Y, and Z.

The detector 1 includes a scanner stand 11, a water tank 12, and a scanner 13. The scanner stand 11 is a base installed almost horizontally. The water tank 12 is placed on the upper surface of the scanner stand 11. The scanner 13 is provided on the upper surface of the scanner stand 11 so as to straddle the water tank 12. The mechanical controller 16 drives the scanner 13 in X, Y, and Z directions. The water tank 12 is filled with water 14 up to the height of level LV1, and a specimen 5 (article to be tested) to be tested is placed at the bottom of the water tank 12 (underwater). The specimen 5 generally has a multi-layer structure. When the transmitted ultrasonic waves enter the specimen 5, reflected waves are generated from the surface of the specimen 5 or a heterogeneous boundary surface. The reflected waves from each part are received by an ultrasonic probe 2 and combined, and then outputted as a reflection signal. The ultrasonic probe 2 is immersed in the water 14 when used. The water 14 functions as a medium for efficiently propagating the ultrasonic waves emitted from the ultrasonic probe 2 into the specimen 5.

The ultrasonic probe 2 transmits ultrasonic waves from its lower end to the specimen 5, and receives the reflected waves back from the specimen 5. The ultrasonic probe 2 is mounted on a holder 15 and can be freely moved in the X, Y, and Z directions by the scanner 13 driven by the mechanical controller 16. The overall control unit 8 causes the ultrasonic probe 2 to transmit ultrasonic waves at a plurality of preset measurement points while moving the ultrasonic probe 2 in the X and Y directions. The transmission direction of the ultrasonic waves from the ultrasonic probe 2 may be changed to another method.

When the ultrasonic probe 2 supplies the reflection signal of the reflected waves received to a flaw detector 3 through a cable 22, the flaw detector 3 performs filtering of the reflection signal, and the like. The A/D converter 6 converts the output signal from the flaw detector 3 into a digital signal and supplies the digital signal to the signal processor 7. The signal processor 7 acquires a two-dimensional image of the interface of the specimen 5 in the measurement region on the XY plane based on the digitized reflection signal to test defects in the specimen 5.

### (Signal Processor 7)

The signal processor 7 processes the reflection signal converted into a digital signal by the A/D converter 6 to detect the internal state of the specimen 5. The signal processor 7 includes general computer hardware including a central processing unit (CPU), a digital signal processor (DSP), a random access memory (RAM), a read-only memory (ROM), and the like. The ROM stores a control program executed by the CPU, a microprogram executed by the DSP, various data, and the like.

In FIG. 1, the functions realized by the control program, the microprogram, and the like are represented as blocks inside the signal processor 7. That is, the signal processor 7 includes an image generation unit 7-1, a defect detection unit 7-2, a data output unit 7-3, and a parameter setting unit 7-4.

The image generation unit 7-1 converts the reflection signal into a luminance value, and generates an image by arranging the luminance values on the XY plane. The defect detection unit 7-2 processes the image generated by the image generation unit 7-1 to detect the internal state such as internal defects in the specimen 5. The data output unit 7-3 outputs the results of testing such as the internal defects detected by the defect detection unit 7-2 to the overall control unit 8. The parameter setting unit 7-4 receives parameters such as measurement conditions inputted from the overall control unit 8 and sets the received parameters in the defect detection unit 7-2 and the data output unit 7-3. Then, the parameter setting unit 7-4 stores these parameters in a storage device 30.

### (Overall Control Unit 8)

The overall control unit 8 includes general computer hardware including a CPU, a RAM, a ROM, a solid state drive (SSD), and the like. The SSD stores an operating system (OS), application programs, various data, and the like. The OS and application programs are expanded into the RAM and executed by the CPU.

The overall control unit 8 is connected to a GUI unit 17 and a storage device 18.

The GUI unit 17 includes an input device (no reference numeral assigned) that receives input of parameters and the like from a user, and a display (no reference numeral assigned) that displays various information to the user. The overall control unit 8 outputs a control command for driving the scanner 13 to the mechanical controller 16. The overall control unit 8 also outputs a control command for controlling the flaw detector 3, the signal processor 7, and the like. As described above, when the signal processor 7 and the overall control unit 8 are collectively treated as a computation processing unit, it can be said that the computation processing unit includes general computer hardware including a CPU, a RAM, a ROM, a solid state drive (SSD), and the like, and that the SSD stores an operating system (OS), application programs, various data, and the like. It can also be said that the OS and application programs are expanded into the RAM and executed by the CPU. The computation processing unit may be connected to the GUI unit 17 and the storage device 18. The computation processing unit may realize the signal processor 7 and the overall control unit 8 by executing a program on common hardware, or may also realize the signal processor 7 and the overall control unit 8 by using separate hardware. Alternatively, the computation processing unit may be partially realized by hardware such as an ASIC or an FPGA.

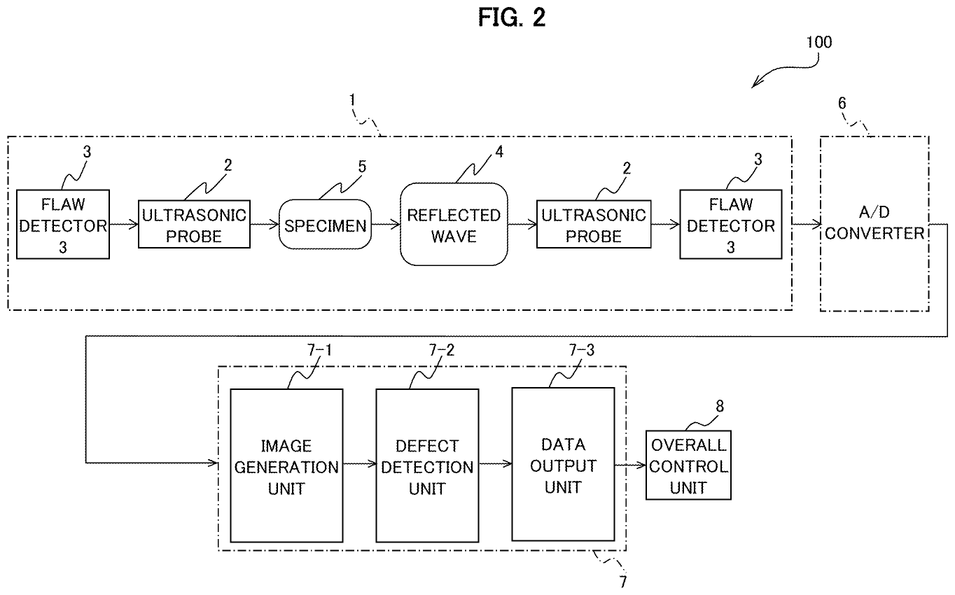

FIG. 2 is a schematic diagram showing the operating principles of the ultrasonic testing device 100.

In FIG. 2, the flaw detector 3 drives the ultrasonic probe 2 by supplying a pulse signal to the ultrasonic probe 2, and the ultrasonic probe 2 generates ultrasonic waves. Thus, the ultrasonic waves are transmitted to the specimen 5 via the water 14 (see FIG. 1). The specimen 5 generally has a multi-layer structure. When the ultrasonic waves enter the specimen 5, reflected waves 4 are generated from the surface of the specimen 5 or a heterogeneous boundary surface. The reflected waves 4 are received by the ultrasonic probe 2 and combined, and then supplied to the flaw detector 3 as a reflection signal. The flaw detector 3 performs filtering of the reflection signal, and the like.

Next, the reflection signal subjected to filtering or the like is converted into a digital signal by the A/D converter 6 and inputted to the signal processor 7. In FIG. 1, a measurement area, which is a range for scanning the ultrasonic probe 2, is predetermined above the specimen 5 (not shown). The overall control unit 8 repeatedly executes the transmission of ultrasonic waves and the reception of reflection signals while scanning the ultrasonic probe 2 in the measurement area. For convenience of explanation, the ultrasonic waves generated by the ultrasonic probe 2 may be referred to as “transmitted waves”.

The image generation unit 7-1 performs processing of converting the reflection signal into a luminance value to generate a cross-sectional image (feature image) of one or a plurality of interfaces of the specimen 5. The defect detection unit 7-2 detects defects such as exfoliation, voids, and cracks based on the generated cross-sectional image of the interface. The data output unit 7-3 generates data to be outputted as the result of testing, such as information on each defect detected by the defect detection unit 7-2 and the cross-sectional image, and outputs the data to the overall control unit 8.

### (Specimen 400)

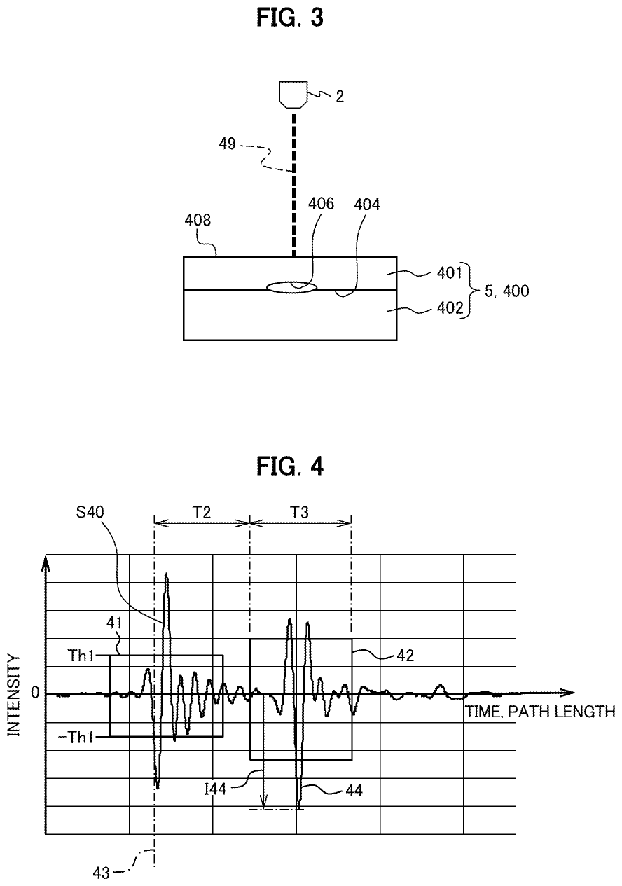

FIG. 3 is a cross-sectional view of a specimen 400 as an example of the specimen 5. In the example shown in FIG. 3, the specimen 400 is formed by joining substrates 401 and 402 made of different materials. In the example shown in FIG. 3, a void 406 is also formed as a defect in a boundary surface 404 between the substrates 401 and 402. When the ultrasonic probe 2 is placed above a surface 408 of the specimen 400 and ultrasonic waves 49 are transmitted, the ultrasonic waves 49 are propagated into the specimen 400. The ultrasonic waves 49 are also reflected at a location where a difference in acoustic impedance appears, such as the surface 408 and the boundary surface 404 of the specimen 400, and the reflected waves are received by the ultrasonic probe 2. Each reflected wave is received by the ultrasonic probe 2 at a timing corresponding to the propagation speed or the distance between the location of reflection and the ultrasonic probe 2. The ultrasonic probe 2 receives a reflection signal obtained by combining the reflected waves.

FIG. 4 is a diagram showing an example of a reflection signal S40 received by the ultrasonic probe 2 in FIG. 3.

The vertical axis in FIG. 4 is the reflection intensity, that is, the peak value of the reflection signal S40. The horizontal axis in FIG. 4 is the reception time, which can be converted into the depth of the specimen 400 and corresponds to the path length of the reflection signal S40. The reflection intensity on the vertical axis has a median value of 0, positive values in the upward direction, and negative values in the downward direction. In the reflection signal S40, peaks with different polarities appear alternately. Hereinafter, each peak is referred to as a local peak. The reception time on the horizontal axis may be set to zero when ultrasonic waves are transmitted, for example, but other timings may be set to zero.

In the example shown in FIG. 4, an S-gate 41 is set as a gate (that is, a time duration) for detecting the reflected waves from the surface 408 (see FIG. 3). Then, in the time range (within the width range) set by the S-gate 41, the timing at which “S40<−Th1” or “Th1<S40” is first satisfied is called a trigger point 43. Here, Th1 is a predetermined threshold. The image generation unit 7-1 of the signal processor 7 first detects the trigger point 43.

The period from the timing delayed by a predetermined time T2 from the trigger point 43 to the timing further delayed by a predetermined time T3 is called a imaging gate 42. The signal processor 7 identifies the local peak in the imaging gate 42 where the absolute value of the reflection signal 40 is at its maximum as the local peak due to the reflected waves from the boundary surface 404 (see FIG. 3). In the example shown in FIG. 4, a local peak 44 is identified as the local peak due to the reflected waves from the boundary surface 404.

As described above, the overall control unit 8 causes the ultrasonic probe 2 to send ultrasonic waves at a plurality of measurement points while moving the ultrasonic probe 2 in the X and Y directions (see FIG. 1). The image generation unit 7-1 of the signal processor 7 identifies the local peak 44 at each measurement point, acquires a peak value 144 at each local peak 44, and converts this peak value into a luminance value. The image generation unit 7-1 generates a cross-sectional image of the joint state of the boundary surface 404 by arranging the luminance values thus obtained on the XY plane. In this event, the absolute value of the peak value 144 becomes high at a location where a defect such as the void 406 exists. As a result, defects such as the void 406 in the boundary surface 404 can be revealed in the cross-sectional image.

### (Specimen 500)

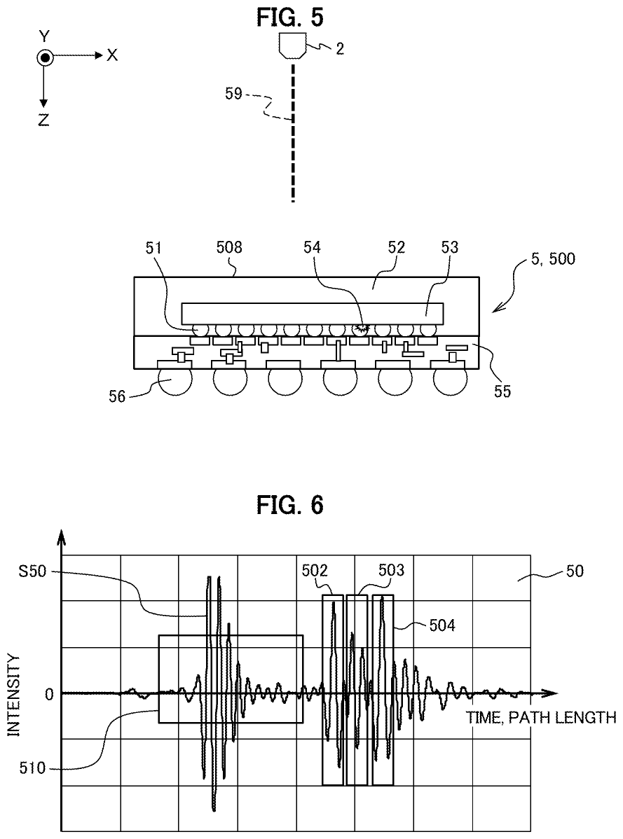

FIG. 5 is a cross-sectional view of a specimen 500 as another example of the specimen 5. In recent mainstream electronic components, the vertical structure is becoming more complex and thinner. The specimen 500 is an example of such an electronic component.

The specimen 500 includes microbumps 51, a resin package 52, a chip 53, a package substrate 55, and a ball grid array 56.

The microbumps 51 connect respective parts of the chip 53 to respective parts of the package substrate 55. A defect 54 due to a crack has occurred in some of the microbumps 51. The resin package 52 is formed of a resin that covers the package substrate 55 and the chip 53, and protects the chip 53 and the like from the outside. The ultrasonic probe 2 is placed above a surface 508 of the specimen 500. When the ultrasonic probe 2 transmits ultrasonic waves 59 to the specimen 500 in the water, the ultrasonic waves 59 are propagated into the specimen 500.

The ultrasonic waves 59 are reflected at locations where differences in acoustic impedance appear, such as the surface 508 of the specimen 500, the upper surface of the chip 53, the lower surface of the chip 53, and the microbumps 51. These reflected waves are combined and received by the ultrasonic probe 2 as a reflection signal.

FIG. 6 is a diagram showing an example of a reflection signal S50 received by the ultrasonic probe 2 in FIG. 5.

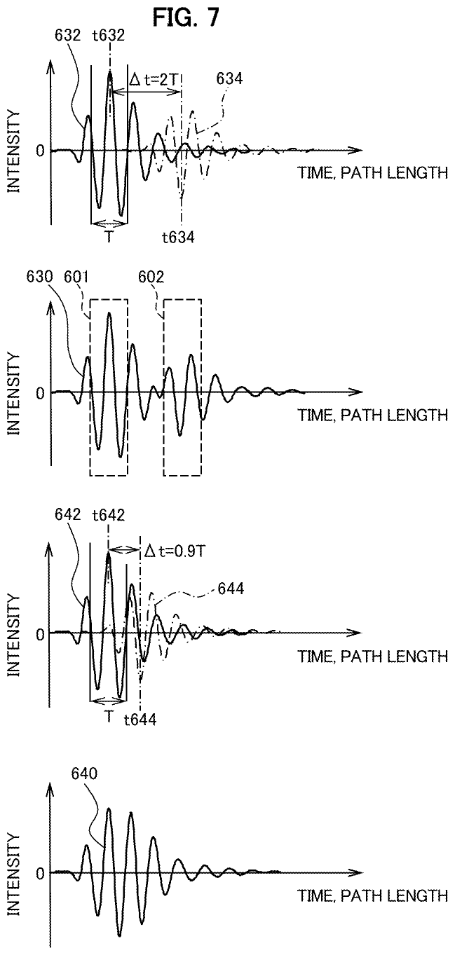

The vertical axis in FIG. 6 is the reflection intensity, that is, the peak value of the reflection signal S50. The horizontal axis in FIG. 6 is the reception time, which can be converted into the depth of the specimen 500 and corresponds to the path length of the reflection signal S50. The reflection intensity on the vertical axis has a median value of 0, positive values in the upward direction, and negative values in the downward direction. In the reflection signal S50, local peaks with different polarities appear alternately. The reception time on the horizontal axis in FIG. 6 and in FIG. 7 to be described later may be set to zero when ultrasonic waves are transmitted, for example, but other timings may be set to zero.

In the example shown in FIG. 6, an S-gate 510 is set as a gate for detecting the reflected waves from the surface 508 of the specimen 500. That is, the reflection signal S50 in the S-gate 510 are mainly due to the reflected waves from the surface 508. The reflection signals S50 in imaging gates 502, 503, and 504 are due to the reflected waves from the upper surface of the chip 53, the lower surface of the chip 53, and the upper surface of the package substrate 55, respectively. As shown in FIG. 6, the generation timings of the reflected waves in the respective parts are close to each other. Therefore, the time durations of the imaging gates 502, 503, and 504 need to be set short. For this reason, it is expected to become difficult to separate and extract the reflection signals at each interface as the electronic components become thinner in the future.

FIG. 7 is a diagram showing an example of various signals when the reception time difference of the reflection signal from each interface becomes smaller than that of FIG. 6.

The reflected waves 632 and 634 shown at the top of FIG. 7 are from two boundary surfaces (not shown). The interval between the peak (time t632) of the reflected wave 632 and the peak (time t634) of the reflected wave 634 is Δt. Here, although the illustration of transmitted waves is omitted, the waveform of the transmitted waves is substantially the same as the similar figure of the reflected wave 632, for example. As for the transmitted waves, “transmission wavelength T” is defined. There are various ways to define the transmission wavelength T, but the transmission wavelength T is defined here as the “length of 1.5 cycles including the peak time”. As shown in FIG. 7, the transmission wavelength T is equal to the “length of 1.5 cycles including the peak time” of the reflected wave 632. In the example shown in FIG. 7, the interval Δt is equal to twice the transmission wavelength T.

The second reflection signal 630 from the top in FIG. 7 is a signal obtained by combining the reflected waves 632 and 634, which is a signal actually obtained by the ultrasonic probe 2. The reflection signal 630 can be divided into a portion substantially caused by the reflected wave 632 and a portion substantially caused by the reflected wave 634. Therefore, by setting imaging gates 601 and 602 shown in FIG. 7, for example, the features of the reflected waves 632 and 634 can be separated and extracted.

The third reflected waves 642 and 644 from the top in FIG. 7 have the same waveforms as those of the reflected waves 632 and 634 described above, respectively. The interval Δt between the peak (time t642) of the reflected wave 642 and the peak (time t644) of the reflected wave 644 is 0.9 T. The reflection signal 640 shown at the bottom in FIG. 7 is a signal obtained by combining the reflected waves 642 and 644, which is a signal actually obtained by the ultrasonic probe 2.

It is difficult to separate and extract the features of the reflected waves 642 and 644 from the waveform of the reflection signal 640 by a simple analysis. Therefore, in this embodiment, when the reflected waves received with such a short time difference are combined to obtain a reflection signal, the features of the reflected waves generated from each joint interface are separated and extracted to reveal a defect.

### Operations of First Embodiment

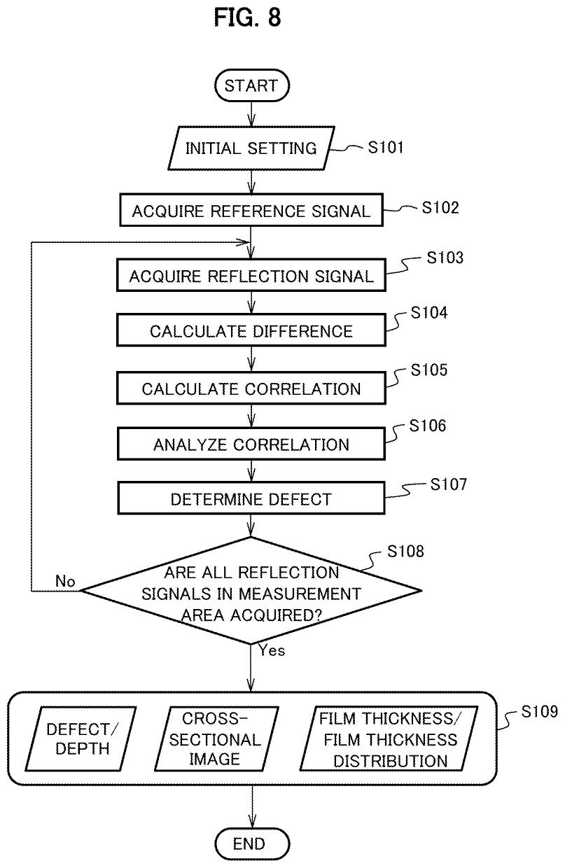

FIG. 8 is a flowchart of an ultrasonic testing program executed by the signal processor 7 and the overall control unit 8.

When the processing proceeds to step S101 in FIG. 8, the overall control unit 8 performs predetermined initial setting for the signal processor 7. Here, the initial setting means to specify the following conditions (1) to (3). For example, the user uses the GUI unit 17 to enter these conditions (1) to (3).

(1) Reference point: As described above, the overall control unit 8 causes the ultrasonic probe 2 to transmit ultrasonic waves at a plurality of preset measurement points. The user specifies any one of these measurement points as a “reference point”. For the measurement point specified as the reference point, a part or all of the processing from step S103 to step S107 may be omitted.

(2) Gate start position and width: As in the case of the S-gate 510 and the imaging gates 502 to 504 shown in FIG. 6, for example, a plurality of gates are determined to analyze the reflection signal (S50 in FIG. 6) in this embodiment. The user specifies the start position and width of each of these gates, depending on the vertical structure of the specimen 5.

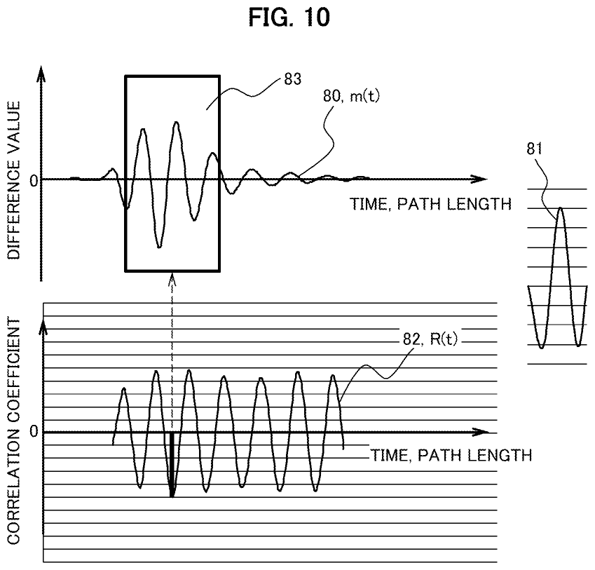

(3) Fundamental wave: The fundamental wave refers to the waveform of the transmission wavelength including the timing at which the absolute value becomes maximum among the transmitted waves. The waveform of the fundamental wave is, for example, substantially the same as the similar figure of the reflected wave 632 in the range of the transmission wavelength T shown in FIG. 7. Since the fundamental wave is determined by the type of the ultrasonic probe 2, the user sets the fundamental wave according to the type of the ultrasonic probe 2 to be applied. An example of the fundamental wave is a fundamental wave 81 shown in FIG. 10. The signal processor 7 and the overall control unit 8 store the fundamental wave as a “signal” in order to compare and calculate the fundamental wave, reflection signal, and the like. Therefore, in the following description, the fundamental wave stored as a signal is also simply referred to as a “fundamental wave”. However, when it is desired to clarify that the fundamental wave is a “signal”, the fundamental wave may be called a “fundamental wave signal”.

In FIG. 8, when the processing proceeds to step S102, the overall control unit 8 causes the signal processor 7 to acquire a reference signal. That is, the overall control unit 8 drives the mechanical controller 16 to move the ultrasonic probe 2 to the reference point. Then, the transmitted waves are outputted from the ultrasonic probe 2. Then, the reflected waves from each part return to the ultrasonic probe 2, and a reflection signal obtained by combining these reflected waves is outputted from the ultrasonic probe 2. The reflection signal is filtered through the flaw detector 3, converted into a digital signal by the A/D converter 6, and supplied to the signal processor 7. The overall control unit 8 causes the image generation unit 7-1 to store the reflection signal at this reference point as a reference signal.

Next, when the processing proceeds to step S103, the overall control unit 8 causes the signal processor 7 to acquire the reflection signal at one measurement point. That is, the overall control unit 8 drives the mechanical controller 16 to move the ultrasonic probe 2 to a measurement point where no reflection signal has been acquired yet. Then, the transmitted waves are outputted from the ultrasonic probe 2. Then, a reflection signal is outputted from the ultrasonic probe 2 and converted into a digital signal to be supplied to the signal processor 7. The overall control unit 8 causes the image generation unit 7-1 to store this reflection signal as a reflection signal at the measurement point.

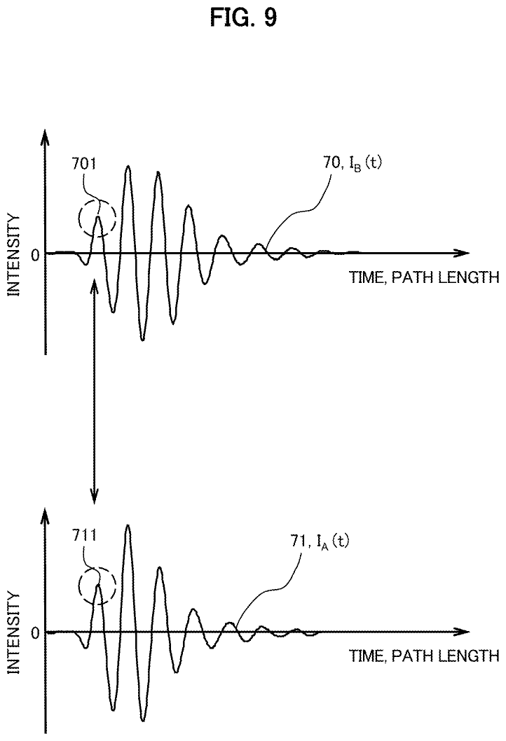

Next, when the processing proceeds to step S104, the image generation unit 7-1 calculates a difference between the reference signal and the reflection signal. Here, with reference to FIG. 9, the difference calculation in step S104 will be briefly described.

FIG. 9 is an example of a waveform diagram of a reflection signal 70 at one measurement point and a reference signal 71 at the reference point. The reflection signal 70 and the reference signal 71 may be referred to as a reflection signal I_{B}(t) and a reference signal I_{A}(t) as a function of the time t. The reflection signal 70 has a local peak 701 and the reference signal 71 has a local peak 711. The local peaks 701 and 711 have slightly different peak values (maximum values) and peak timings (time to reach the maximum values).

Therefore, the image generation unit 7-1 normalizes (transforms) the waveform of the reflection signal 70 so that the peak values and peak timings of the local peaks 701 and 711 match. That is, the reflection signal 70 is expanded and contracted in the vertical axis direction so that the peak values of the local peaks 701 and 711 match, and the reflection signal 70 is shifted in the horizontal axis direction so that the peak timings match. The reflection signal I_{B}(t) thus normalized is called the normalized reflection signal I′_{B}(t). The reflection signal I_{B}(t) and the normalized reflection signal I′_{B}(t) may be collectively referred to as the “reflection signal (I_{B}(t), I′_{B}(t))”. As for the normalization, the waveforms may be deformed so that only the peak timings match, or may be deformed so that only the peak values match.

In order to obtain the normalized reflection signal I′_{B}(t), it is necessary to associate the local peaks 701 and 711, which are the criteria for normalization. Various methods such as a surface trigger point method, a probability propagation method, a normalized cross-correlation method, a DP matching method are known, but any method may be applied as long as local peaks can be collated. Once the normalized reflection signal I′_{B}(t) is obtained as described above, the image generation unit 7-1 calculates a difference signal m(t) based on the following equation (1).

[Expression 1]

m(t)=I′_{B}(t)−I_{A}(t) Equation (1)

In FIG. 8, when the processing proceeds to step S105, the image generation unit 7-1 performs a correlation calculation between the fundamental wave and the difference signal m(t). The details thereof will be described with reference to FIG. 10.

Here, FIG. 10 is a waveform diagram showing an example of the difference signal m(t) and a correlation coefficient R(t). A waveform 80 shown in FIG. 10 is an example of the difference signal m(t), and the vertical axis of the waveform 80 is the difference value. As described above, a fundamental wave 81 corresponds to the transmission waveform specific to the ultrasonic probe 2, and is set in step S101 according to the type of the ultrasonic probe 2.

In FIG. 10, a waveform 82 is an example of the correlation coefficient R(t). The correlation coefficient R(t) is calculated based on the following equation (2) while scanning the fundamental wave 81 in the X-axis direction with respect to the difference signal m(t). In the following equation (2), f(n) is the reflection intensity of the fundamental wave 81, and n is the time length (number of data points) of the fundamental wave 81.

$$[ Expression 2 ]$$

$$Equation ( 2 )$$

$$R ( t ) = \frac{\begin{matrix}{\sum }_{1}^{n} ( m ( t + n ) \cdot f ( n ) ) - \\ ( {\sum }_{1}^{n} m ( t + n ) ) \cdot ( {\sum }_{1}^{n} f ( n ) ) / n\end{matrix}}{\sqrt{\begin{matrix}( {\sum }_{1}^{n} {( m ( t + n ) )}^{2} - ( {( {\sum }_{1}^{n} ( m ( t + n ) ) )}^{2} / n ) \cdot \\ ( {\sum }_{1}^{n} ( {( f ( n ) )}^{2} ) - ( \frac{{{\sum }_{1}^{n} f ( n ) )}^{2}}{n} )\end{matrix}}}$$

In FIG. 8, when the processing proceeds to step S106, the image generation unit 7-1 performs a correlation analysis based on the correlation coefficient R(t) (see FIG. 10). That is, the image generation unit 7-1 calculates at least one feature amount within the range of a feature calculation gate 83 (gate) shown in FIG. 10. Here, the feature calculation gate 83 can be defined by setting a start time and a time duration for the reference signal obtained in S102. The ultrasonic testing device may be provided with the feature calculation gate 83 without the imaging gate 42, or may be provided with both. When the device includes both, the imaging gate and the feature calculation gate may have the following relationship, for example.
The feature calculation gate 83 and the imaging gate 42 are the same.
The feature calculation gate 83 has a partial overlap or inclusion relationship with the imaging gate 42.
The feature calculation gate 83 and the imaging gate 42 do not overlap.

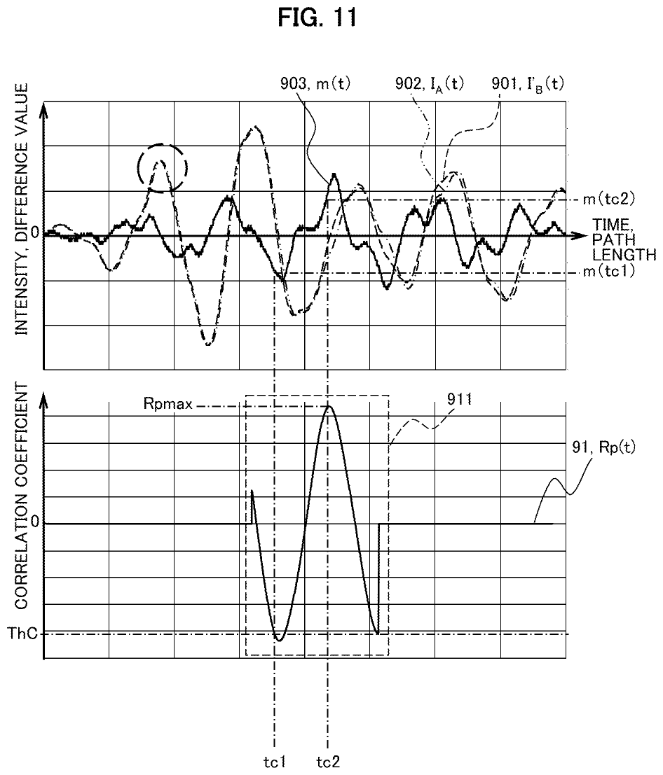

FIG. 11 is a waveform diagram showing an example of the normalized reflection signal I′_{B}(t), the reference signal I_{A}(t), the difference signal m(t), and a partial correlation coefficient Rp(t).

In FIG. 11, a waveform 901 is an example of the normalized reflection signal I′_{B}(t), a waveform 902 is an example of the reference signal I_{A}(t), and a waveform 903 is an example of the difference signal m(t). However, the difference signal m(t) is expanded in the vertical direction.

A feature calculation gate 911 (gate) is narrower than the feature calculation gate 83 (see FIG. 10). A waveform 91 is an example of a waveform having a partial correlation coefficient Rp(t) that matches the correlation coefficient R(t) (see FIG. 10) within the feature calculation gate 911 and becomes “0” in other parts. The image generation unit 7-1 calculates the feature amount based on the waveform 91 within the feature calculation gate 911, that is, the partial correlation coefficient Rp(t).

That is, the image generation unit 7-1 detects one or more of the feature amounts listed below based on the partial correlation coefficient Rp(t) within the feature calculation gate 911.
Whether or not there is a part where the partial correlation coefficient Rp(t) is less than a predetermined threshold ThC,
Time tc1 (reception timing) when the partial correlation coefficient Rp(t) becomes less than the threshold ThC,
Difference signal m(tc1) at time tc1
Maximum absolute value Rpmax of the partial correlation coefficient Rp(t),
Time tc2 (reception timing) when the maximum value Rpmax is detected,
Polarity of the partial correlation coefficient Rp(t) at time tc2,
Difference signal m(tc2) at time tc2

The times tc1 and tc2 described above correspond to the reception timing of the reflected waves corresponding to the feature calculation gate 911.

In FIG. 8, when the processing proceeds to step S107, the defect detection unit 7-2 determines whether or not there is a defect based on the feature amount detected in the correlation analysis (S106). For example, it can be determined that “there is a defect” if “the minimum value of the partial correlation coefficient Rp(t)<the threshold ThC” is satisfied within the feature calculation gate 911, and, if not, “there is no defect”. When it is determined that “there is a defect”, the defect detection unit 7-2 also calculates the “depth of occurrence” of the defect based on the time tc1 in FIG. 11.

Next, when the processing proceeds to step S108, the overall control unit 8 determines whether or not the reflection signals have been acquired for all the measurement points in the measurement area. When it is determined as “No” here, the processing returns to step S103, and the processing of steps S103 to S107 is repeated for the measurement points for which no reflection signals have been acquired yet.

Then, when the reflection signals have been acquired for all the measurement points, it is determined as “Yes” in step S108, and the processing proceeds to step S109.

In step S109, the image generation unit 7-1 generates a cross-sectional image (feature image) by arranging the feature amounts at each measurement point in the X and Y directions. The data output unit 7-3 outputs the following information to the overall control unit 8.
Cross-sectional image used for defect determination,
Whether or not there are defects in the cross-sectional image, and if there are defects, the number of defects,
Film thickness and film thickness distribution of each part in the specimen 5
Graph of difference signal m(t)
Graph of correlation coefficient R(t) or partial correlation coefficient Rp(t)

Here, the cross-sectional image described above contains the position (coordinates) of occurrence of the defect in the X and Y directions, the dimensions of each defect, and information indicating the position of occurrence in the time direction (Z direction in FIG. 1), that is, the depth of the defect. The overall control unit 8 displays the data supplied from the data output unit 7-3 on the display of the GUI unit 17. Thus, the processing of this routine is completed.

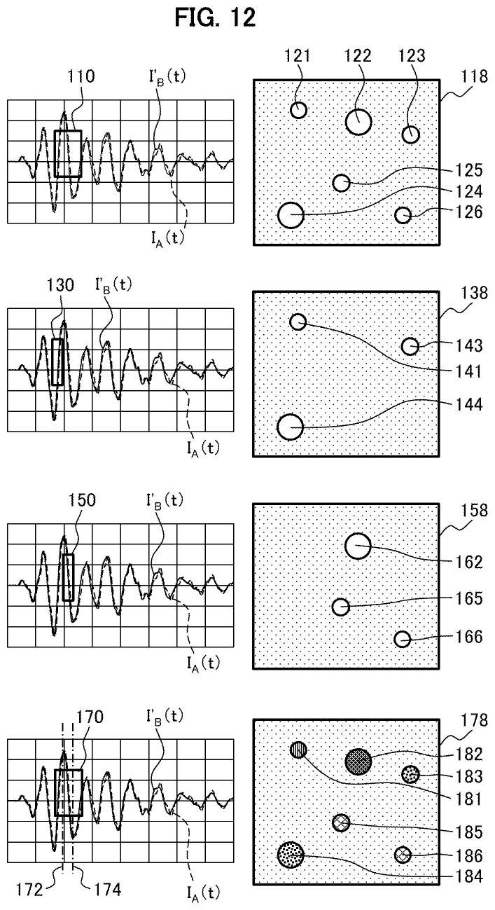

FIG. 12 is a diagram showing examples of various feature calculation gates and corresponding cross-sectional images. The term “cross-sectional image” as used herein refers to a two-dimensional image of the feature amount detected in the present specification. The surface to be converted into two dimensions is considered to be a surface along the X and Y directions (that is, a surface along the scanning surface of the probe), but may be a surface along another reference surface. The reference surface is, for example, a surface having a normal along the traveling direction of ultrasonic waves, or a surface of an article to be tested, that is, a surface on which ultrasonic waves are made incident.

It is assumed that a feature calculation gate 110 shown in FIG. 12 is set for the reference signal I_{A}(t) and the normalized reflection signal I′_{B}(t) shown at the top of FIG. 12. The feature calculation gate 110 has a width of about one transmission wavelength, that is, a width such that positive and negative local peaks are included once. A cross-sectional image 118 (feature image) is an image acquired corresponding to the feature calculation gate 110, and has six circular defect regions 121 to 126. Particularly, when each layer constituting the specimen 5 (see FIG. 1) is thin, if the width of the feature calculation gate 110 is set to about one transmission wavelength, a situation may occur in which the cross-sectional image 118 simultaneously contains defects of different joint surfaces. The defect regions 121 to 126 shown in FIG. 12 are also actually any of a plurality of different joint surfaces, but it is difficult only with the cross-sectional image 118 to identify the joint surface where the defect has occurred.

The second feature calculation gate 130 from the top in FIG. 12 has a width of about ½ transmission wavelength. This feature calculation gate 130 does not include the local peak of the reference signal I_{A}(t) or the normalized reflection signal I′_{B}(t). According to this embodiment, defects can be detected even in a feature calculation gate that does not include any local peak, such as the feature calculation gate 130. A cross-sectional image 138 (feature image) is an image acquired corresponding to the feature calculation gate 130, and has three circular defect regions 141, 143, and 144. These defect regions 141, 143, and 144 correspond to the same defects as the defect regions 121, 123, and 124 in the cross-sectional image 118, respectively.

The third feature calculation gate 150 from the top in FIG. 12 has the same width as the feature calculation gate 130, but is set at a position shifted backward in the horizontal axis (time axis) direction. A cross-sectional image 158 (feature image) is an image acquired corresponding to the feature calculation gate 150, and has three circular defect regions 162, 165, and 166. These defect regions 162, 165, and 166 correspond to the same defects as the defect regions 122, 125, and 126 in the cross-sectional image 118, respectively. Such narrow feature calculation gates 130 and 150 make it possible to distinguish and detect defects that exist at different depths.

A feature calculation gate 170 shown at the bottom in FIG. 12 has the same width as the feature calculation gate 110, and is divided into a plurality of sections having timings 172 and 174 as boundaries in the horizontal axis (time axis) direction. Inside the feature calculation gate 170, it is distinguished which sections the features detected in the correlation analysis (S106) are included. A cross-sectional image 178 (feature image) is an image acquired corresponding to the feature calculation gate 170, and has six circular defect regions 181 to 186.

These defect regions 181 to 186 correspond to the same defects as the defect regions 121 to 126 in the cross-sectional image 118, respectively. However, the defect regions 181 to 186 are all displayed differently depending on the section in the feature calculation gate 170. In the example shown in FIG. 12, display modes such as hatching, mesh, and dots are used, but different “display colors” may be assigned to the defect regions 181 to 186 depending on the section in the feature calculation gate 170. As described above, in the example where the feature calculation gate 170 is applied, it is possible to distinguish and detect a plurality of defects having different depths of occurrence, and it is possible to generate the cross-sectional image 178 in which these defects can be displayed separately. As described above, the accuracy of the depth is higher than that of the time duration between the local peaks of the reflection signal. In other words, it is possible to achieve higher accuracy than that of the path length obtained by the time duration between the local peaks of the reflection signal.

### Advantageous Effects of First Embodiment

As described above, the ultrasonic testing device 100 of this embodiment includes: an ultrasonic probe (2) that generates ultrasonic waves and transmits the same to an article to be tested (5), and that receives reflected waves reflected from the article to be tested (5); and a computation processing unit (7, 8). The computation processing unit (7, 8): (A) sets a gate (911) indicating a start time and a time duration for a subject of analysis of the reflected waves; (B) as pertains to each of a plurality of measurement points, (B1) acquires a reflection signal (I_{B}(t), I′_{B}(t)) indicating the intensity of the reflected waves at each time, (B2) calculates a difference signal (m(t)) that is the difference between the reflection signal (I_{B}(t), I′_{B}(t)) and a reference signal (I_{A}(t)), and (B3) calculates a feature amount with respect to the difference signal (m(t)) within the gate (911); (C) detects defects on the basis of the feature amounts for the plurality of measurement points; and (D) outputs information indicating the depth of the defects along the transmission direction of the ultrasonic waves.

Thus, according to the present invention, it is possible to suitably detect internal defects in a specimen. More specifically, it is possible to accurately identify the depth of the defects detected within the set gate.

From another viewpoint, the ultrasonic testing device 100 of this embodiment includes: an ultrasonic probe (2) that generates ultrasonic waves and transmits the same to an article to be tested (5), and that receives reflected waves reflected from the article to be tested (5); and a computation processing unit (7, 8) that outputs a two-dimensional image based on a feature amount calculated based on the reflected waves. The computation processing unit (7, 8): (1) sets a gate (911) indicating a start time and a time duration for a subject of analysis of the reflected waves; (2) as pertains to one or more pixels contained in the two-dimensional image, (2A) acquires a reflection signal (I_{B}(t), I′_{B}(t)) indicating the intensity of the reflected waves at each time, (2B) calculates a difference signal (m(t)) that is the difference between the reflection signal (I_{B}(t), I′_{B}(t)) and a reference signal (I_{A}(t)), and (2C) calculates a feature amount with respect to the difference signal (m(t)) within the gate (911); (3) detects defects on the basis of the feature amounts; and (4) generates a two-dimensional image containing information indicating the depth of the defects along the transmission direction of the ultrasonic waves.

Thus, according to the present invention, it is possible to accurately identify the depth of the defects based on the generated two-dimensional image.

The feature amount includes any of the following: the state of the correlation coefficient (R(t)) between the predetermined fundamental wave signal (81) and the difference signal (m(t)) (for example, whether or not there is a portion where Rp(t)<ThC is satisfied); the reception timing (tc1, tc2) of the reflected waves calculated based on the correlation coefficient (R(t)); and the difference signal (m(tc1), m(tc2)) at the reception timing (tc1, tc2). Thus, it is possible to accurately extract feature amounts that appear in the state of the correlation coefficient (R(t)), the reception timing of the reflected waves (tc1, tc2), or the difference signal (m(tc1), m (tc2)) at the reception timing (tc1, tc2).

The fundamental wave signal (81) is a signal defined corresponding to the characteristics of the ultrasonic probe (2). Thus, it is possible to extract accurate feature amounts according to the characteristics of the ultrasonic probe (2).

The reference signal (I_{A}(t)) in this embodiment is a reflection signal (I_{B}(t), I′_{B}(t)) obtained at the reference point. Therefore, the reference signal (I_{A}(t)) can be easily obtained.

The set gates (130, 150) can be set not to include the local peaks of the reflection signals (I_{B}(t), I′_{B}(t)) in the time range from the start time to the end of the time duration. Thus, it is possible to accurately distinguish and detect defects present at different depths based on the reflection signal in a narrow time range that includes no local peak.

The information on the depth of defects along the transmission direction of the ultrasonic waves includes: higher accuracy than that of the time duration between the local peaks of the reflection signal (I_{B}(t), I′_{B}(t)) or higher accuracy than that of the path length obtained by the time duration between the local peaks of the reflection signal.

Thus, it is possible to accurately distinguish and detect defects present in a range narrower than the difference in depth corresponding to the time duration between the local peaks.

### Second Embodiment

Next, an ultrasonic testing device according to a second embodiment of the present invention will be described. The hardware configuration and software contents of this embodiment are the same as those of the first embodiment (FIGS. 1 to 12), but step S102 (see FIG. 8) for acquiring a reference signal is different in detail from that of the first embodiment. In the first embodiment described above, the reference point for acquiring the reference signal is preferably selected from among the measurement points of the specimen 5 at which no defects have occurred. However, it may be difficult to identify the “measurement point without defects” in advance. Therefore, in step S102 of this embodiment, the reference signal is acquired through the procedure described below.

(1) First, the overall control unit 8 and the signal processor 7 (see FIG. 1) set an imaging gate corresponding to a desired boundary surface of the specimen 5 in the image generation unit 7-1 (see FIG. 2), and cause the image generation unit 7-1 to acquire a reflection signal at each measurement point. Thus, the image generation unit 7-1 generates a cross-sectional image corresponding to the imaging gate.

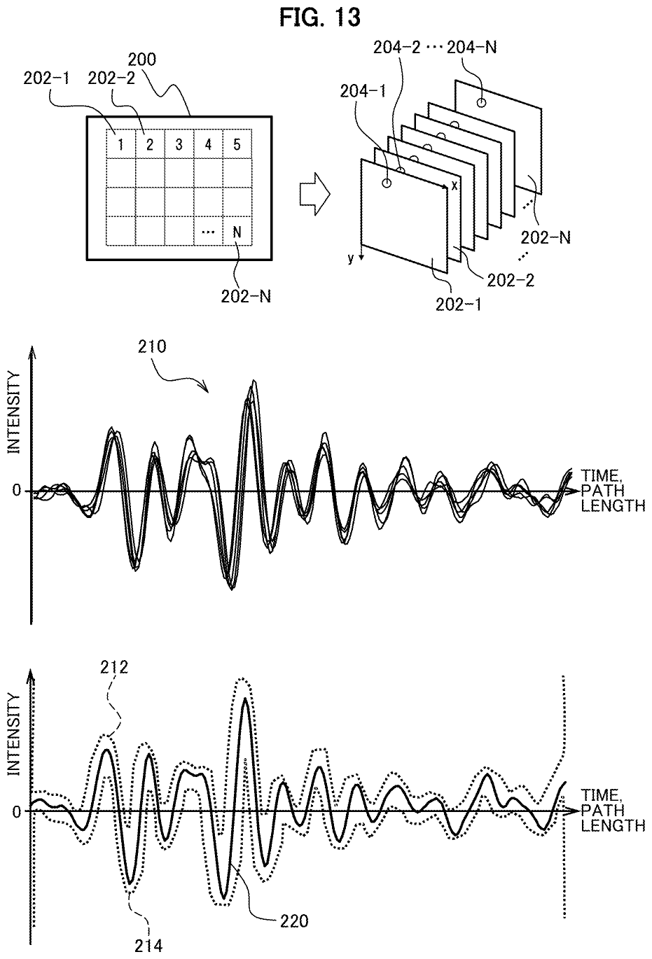

FIG. 13 is an operation explanatory diagram for acquiring a reference signal in the second embodiment. A cross-sectional image 200 shown at the top of FIG. 13 is assumed to be a cross-sectional image generated as described above.

(2) Then, the overall control unit 8 and the signal processor 7 divide the cross-sectional image 200 into a plurality of subregions having a similar (for example, the same) pattern structure. N subregions 202-1 to 202-N shown at the top of FIG. 13 are the subregions obtained by the division. Here, the values of “1” to “N” may be referred to as shot numbers.

(3) Next, the overall control unit 8 and the signal processor 7 extract measurement points having a similar (for example, the same) pattern in each of the subregions 202-1 to 202-N. In FIG. 13, it is assumed that N measurement points 204-1 to 204-N are the extracted measurement points.

(4) Thereafter, the overall control unit 8 and the signal processor 7 cause the image generation unit 7-1 to acquire N reflection signals at the N measurement points 204-1 to 204 -N while sequentially moving the ultrasonic probe 2 to these measurement points. These N reflection signals may include a signal containing a reflected wave due to a defect. The second waveform group 210 from the top in FIG. 13 is a superposition of the N reflection signals acquired based on a specific local peak.

(5) Subsequently, the overall control unit 8 and the signal processor 7 calculate a median value of the intensity of the reflection signal at each time t of the waveform group 210. Lines 212 and 214 indicated by the broken lines at the bottom of FIG. 13 represent the upper and lower limits of each waveform belonging to the waveform group 210. The waveform 220 is a waveform connecting the median values of each waveform belonging to the waveform group 210 at each time t. In this embodiment, this waveform 220 is applied as the reference signal I_{A}(t).

As described above, according to this embodiment, the computation processing unit (7, 8) (E) acquires the reference signal (I_{A}(t)) by performing the predetermined statistical processing on the reflection signal (I_{B}(t), I′_{B}(t)) for the plurality of measurement points.

Thus, even when some of the reflection signals contain the influence of the defect, the reference signal I_{A}(t) in which the influence of the defect is suppressed can be acquired.

### Third Embodiment

Next, an ultrasonic testing device according to a third embodiment of the present invention will be described. The hardware configuration and software contents of this embodiment are the same as those of the first embodiment (FIGS. 1 to 12). However, in the initial setting of this embodiment (step S101 in FIG. 8), the operation of specifying the “start position and width of each gate” is different from that of the first embodiment.

In the first embodiment, as described above, the start position and width of each gate are specified according to the vertical structure of the specimen 5. However, in this embodiment, the user inputs the “vertical structure information” on the specimen 5 to the overall control unit 8. Here, the vertical structure information is a list of the “layer number”, “material”, and “thickness” of each layer of the specimen 5. The layer number” is a number assigned in ascending order from “1” in the order closest to the ultrasonic probe 2 in FIG. 1. The vertical structure information is, for example, “1: epoxy resin sealant, 500 μm, 2: Si (silicon), 20 μm, 3: Al (aluminum), 7 μm, 4: Cu (copper), 7 μm, . . . ”.

Since the propagation speed of ultrasonic waves in each material is known, the propagation time of ultrasonic waves in each layer can be obtained by specifying the material and thickness. Therefore, the overall control unit 8 calculates the time required for the reflected waves to return to the ultrasonic probe 2 from the boundary surface of each layer after the transmitted waves are outputted from the ultrasonic probe 2, and determines the start position and width of each gate. The vertical structure information described above may be obtained by the overall control unit 8 based on CAD (Computer Aided Design) data on the specimen 5.

As described above, according to the ultrasonic testing device of this embodiment, the computation processing unit (7, 8): (F) acquires vertical structure information on the article to be tested (5), (G) sets a gate (911) based on the vertical structure information, and (H) displays information indicating the depth of defects on a display together with a difference signal (m(t)).

Thus, since the gate can be automatically set based on the vertical structure information, the user's trouble can be saved.

### Modified Example

The present invention is not limited to the embodiments described above, and various modifications are possible. The above embodiments are exemplified for the purpose of explaining the present invention in an easy-to-understand manner, and are not necessarily limited to those having all the configurations described. It is possible to replace a part of the configuration of one embodiment with the configuration of another embodiment, and it is also possible to add the configuration of another embodiment to the configuration of one embodiment. It is possible to delete a part of the configuration of each embodiment, or add/replace another configuration. The control lines and information lines shown in the drawings show what is considered necessary for explanation, and do not necessarily show all the control lines and information lines necessary for the product. In practice, it can be considered that almost all configurations are interconnected. Possible modifications to the above embodiments are as follows, for example.

(1) In the second embodiment described above, the description is given of an example where the “median value” of a plurality of reflection signals is applied to obtain the reference signal by statistical processing. However, the statistical processing is not limited to the processing for obtaining the median value, and other statistical computation processing such as the average value can be applied.

(2) In the second embodiment, the obtained cross-sectional image 200 is divided into the measurement points 204-1 to 204-N, and a plurality of measurement points 204-1 to 204-N to be applied to the statistical processing are selected. However, the measurement points to be applied to the statistical processing may be automatically selected from specimen layout information, design data, and the like. In the second embodiment, a plurality of measurement points 204-1 to 204-N may be randomly selected from the measurement area.

(3) Since the hardware of the signal processor 7 and the overall control unit 8 in the above embodiments can be realized by a general computer, the flowchart shown in FIG. 8 and other programs and the like for executing the various processing described above may be stored in a storage medium or distributed via a transmission path.

(4) Although the processing shown in FIG. 8 and other processing described above have been described as software-like processing using programs in the above embodiments, some or all of them may be replaced with hardware-like processing using an ASIC (Application Specific Integrated Circuit), an FPGA (Field Programmable Gate Array) or the like.

(5) The part that generates the reflection signal based on the reflected waves may be other than the flaw detector 3 and the A/D converter 6. For example, the ultrasonic probe 2 may generate a reflection signal. In this case, it can be said that the ultrasonic probe 2 includes the flaw detector 3 and the A/D converter 6.

(6) As described above, the two-dimensional surface of the cross-sectional image does not necessarily correspond to the measurement point (position) of the ultrasonic probe 2, but need only generate a two-dimensional image on the surface along the other reference surface. That is, for each pixel (for example, a dot, a point, or a minute area) included in the cross-sectional image, ultrasonic waves may be transmitted to different positions on the surface of the article to be tested, the reflected waves may be received, and the processing described in the present specification may be performed on the reflection signal acquired using the reflected waves. The image may include only one pixel. In other words, the computation processing unit (7, 8) may: (1) set a gate (for example, the feature calculation gate 83 shown in FIG. 10) indicating the start time and time duration for a subject of analysis of the reflected waves; (2) as pertains to one or more pixels included in the two-dimensional image: (2A) acquire a reflection signal indicating the intensity of the reflected waves at each time, (2B) calculate a difference signal that is the difference between the reflection signal and a reference signal, (2C) calculate the feature amount with respect to the difference signal within the gate; (3) detect defects on the basis of the feature amount; and (4) generate the two-dimensional image containing information indicating the depth of the defects along the transmission direction of the ultrasonic waves.

### REFERENCE SIGNS LIST

2 ultrasonic probe
5 specimen (article to be tested)
7 signal processor (computation processing unit)
8 overall control unit (computation processing unit)
81 fundamental wave (fundamental wave signal)
83, 130, 150, 911 feature calculation gate (gate)
100 ultrasonic testing device
118, 138, 158, 178 cross-sectional image (feature image)
tc1, tc2 time (reception timing)
I_{A}(t) reference signal
I_{B}(t) reflection signal
I′_{B}(t) normalized reflection signal (reflection signal)
m(t) difference signal
R(t) correlation coefficient
Rp(t) partial correlation coefficient (correlation coefficient)

1. An ultrasonic testing device comprising:
an ultrasonic probe that generates ultrasonic waves and transmits the same to an article to be tested, and that receives reflected waves reflected from the article to be tested; and
a computation processing unit, wherein
the computation processing unit:
(A) sets a gate indicating a start time and a time duration for a subject of analysis of the reflected waves;
(B) as pertains to each of a plurality of measurement points,
(B1) acquires a reflection signal indicating the intensity of the reflected waves at each time,
(B2) calculates a difference signal that is the difference between the reflection signal and a reference signal, and
(B3) calculates a feature amount with respect to the difference signal within the gate;
(C) detects defects on the basis of the feature amounts for the plurality of measurement points; and
(D) outputs information indicating the depth of the defects along the transmission direction of the ultrasonic waves.

2. The ultrasonic testing device according to claim 1, wherein
the feature amount includes any of the state of the correlation coefficient between the predetermined fundamental wave signal and the difference signal, the reception timing of the reflected waves calculated based on the correlation coefficient, and the difference signal at the reception timing.

3. The ultrasonic testing device according to claim 2, wherein
the fundamental wave signal is a signal defined corresponding to the characteristics of the ultrasonic probe.

4. The ultrasonic testing device according to claim 1, wherein
the reference signal is a reflection signal obtained at a reference point.

5. The ultrasonic testing device according to claim 1, wherein
the computation processing unit (E) acquires the reference signal by performing predetermined statistical processing on the reflection signal for the plurality of measurement points.

6. The ultrasonic testing device according to claim 2, wherein
the computation processing unit:
(F) acquires vertical structure information on the article to be tested;
(G) sets the gate based on the vertical structure information; and
(H) displays information indicating the depth of the defects on a display together with the difference signal.

7. The ultrasonic testing device according to claim 1, wherein
the set gates can be set not to include local peaks of the reflection signals in a time range from the start time to the end of the time duration.

8. The ultrasonic testing device according to claim 1, wherein
the information on the depth of defects along the transmission direction of the ultrasonic waves includes:
higher accuracy than that of the time duration between the local peaks of the reflection signal, or
higher accuracy than that of the path length obtained by the time duration between the local peaks of the reflection signal.

9. An ultrasonic testing method for analyzing reflected waves in a computation processing unit using an ultrasonic probe that generates ultrasonic waves, transmits the same to an article to be tested, and receives the reflected waves reflected from the article to be tested, comprising the steps of:
(A) setting a gate indicating a start time and a time duration for a subject of analysis of the reflected waves;
(B) as pertains to each of a plurality of measurement points,
(B1) acquiring a reflection signal indicating the intensity of the reflected waves at each time,
(B2) calculating a difference signal that is the difference between the reflection signal and a reference signal, and
(B3) calculating a feature amount with respect to the difference signal within the gate;
(C) detecting defects on the basis of the feature amounts for the plurality of measurement points; and
(D) outputting information indicating the depth of the defects along the transmission direction of the ultrasonic waves.

10. The ultrasonic testing method according to claim 9, wherein
the feature amount includes any of the state of the correlation coefficient between the predetermined fundamental wave signal and the difference signal, the reception timing of the reflected waves calculated based on the correlation coefficient, and the difference signal at the reception timing.

11. The ultrasonic testing method according to claim 10, wherein
the fundamental wave signal is a signal defined corresponding to the characteristics of the ultrasonic probe.

12. The ultrasonic testing method according to claim 9, wherein
the reference signal is a reflection signal obtained at a reference point.

13. The ultrasonic testing method according to claim 9, further comprising the step of
(E) acquiring the reference signal by performing predetermined statistical processing on the reflection signal for the plurality of measurement points.

14. The ultrasonic testing method according to claim 10, further comprising the step of
(F) acquiring vertical structure information on the article to be tested;
(G) setting the gate based on the vertical structure information; and
(H) displaying information indicating the depth of the defects on a display together with the difference signal.

15. The ultrasonic testing method according to claim 9, wherein
the set gates can be set not to include local peaks of the reflection signals in a time range from the start time to the end of the time duration.

16. An ultrasonic testing device comprising:
an ultrasonic probe that generates ultrasonic waves and transmits the same to an article to be tested, and that receives reflected waves reflected from the article to be tested; and
a computation processing unit that outputs a two-dimensional image based on a feature amount calculated based on the reflected waves, wherein
the computation processing unit:
(1) sets a gate indicating a start time and a time duration for a subject of analysis of the reflected waves;
(2) as pertains to one or more pixels contained in the two-dimensional image,
(2A) acquires a reflection signal indicating the intensity of the reflected waves at each time,
(2B) calculates a difference signal that is the difference between the reflection signal and a reference signal, and
(2C) calculates a feature amount with respect to the difference signal within the gate;
(3) detects defects on the basis of the feature amounts; and
(4) generates a two-dimensional image containing information indicating the depth of the defects along the transmission direction of the ultrasonic waves.
